(19) United States
(12) Patent Application Publication
(10) Pub. No.: US 2006/0165502 A1
(43) Pub. Date: Jul. 27, 2006

(54) Linear electric servo motor actuated screw thread tapper

(76) Inventor: Anthony Salerno JR., Pinckney, MI (US)

Correspondence Address: James M Deimen, Suite 300, 320 N Main Street, Ann Arbor, MI, 48104-1192, US

(21) Appl. No.: 10/514,700

(22) PCT Filed: May 19, 2003
(86) PCT No.: PCT/US03/15865

§ 371 Date: Jul. 14, 2005

Related U.S. Application Data
(60) Provisional application No. 60/381,311, filed on May 17, 2002.

(51) Int. Cl. B23D 7/00

(52) U.S. Cl. 409/235

(57) ABSTRACT

An all electric screw thread tapper comprises an electric servo rotational motor (20) controlled as to shaft position, velocity and acceleration in combination with a linear electric servo motor (16) controlled as to armature position, velocity and acceleration. With motion controller and built-in high speed processor controls, the parameters for each job or part can be touch screened in.

### BACKGROUND OF THE INVENTION

The field of the invention pertains to industrial high production screw thread tapping machinery, and, in particular, to tappers that automatically extend and retract as fixtured work pieces momentarily stop at the tapping station.

Currently, in conventional tappers, some of which technology dates back to the 1930's, reversible cyclic rotational motion of the tap is provided by an electric, pneumatic or hydraulic motor. Linear reversible motion of the tap is provided by a pneumatic or hydraulic cylinder actuator or a leadscrew or ballscrew actuator. In many high production settings, the tapping time reduces throughput creating a bottleneck and material handling, storage, and space problems. Therefore, the tapping time determines overall production rate because other production steps take less time.

The linear, pneumatic or hydraulic actuators have been found to require very frequent repair and replacement of mechanical components and control valves to avoid unacceptable scrappage rates and customer rejections. In particular, fluctuations in plant air supply flow rates and pressure will throw off previously properly set parameters for a specific threaded hole. Also, the leadscrew and ballscrew systems are known to wear and produce improper feed rates. The fluctuations cause inconsistencies in thread quality, rejection of parts already shipped to customers under just-in-time schedules, quarantine of the shipped parts, expedited and certified replacement parts under 100% inspection, and unacceptable costs for each rejection to the manufacturing companies. In addition, tool life is considerably diminished due to improper feed rates.

With some conventional tapping equipment, new set-ups for a new part or a new run of a previous part result in scrappage of hundreds of parts just to obtain repeated gaging that meets thread specifications. With some models of tappers, one to four hours are required to change leadscrews for a change of pitch. Where several changeovers or new set-ups are required per day, costly skilled worker time and lost production time result. When production is at the rate of a few seconds or less per tap, lost production can be many thousands per day.

In addition, conventional tapping machines have features that interfere with quick changeovers and quick tap changes. With a view toward minimizing set-up and changeover time, quality rejections, frequent maintenance due to fluctuations in air flow and pressures, leadscrew error and ballscrew error, the following improvements have been developed.

### SUMMARY OF THE INVENTION

The invention comprises the elimination of mechanical, pneumatic or hydraulic actuators or motors and outdated controls by replacement with electric servo motors and state-of-the-art controls, in particular, for linear movements. Modem rotational electric motors, such as servos and “stepper motors,” can be very carefully controlled not only as to rotational speed and acceleration but also as to rotational position. Likewise, linear electric servo motors (actuators) now can be very accurately controlled as to armature speed, acceleration and position with feedback from a built-in encoder, drive output signals, and motion controllers. In addition, this machine can monitor and display feedback from current load on the spindle in real time with adjustable ranges for each job stored in memory, and with each job to turn the machine off and send a message to the display for the operator to change the tool. The servo tapper disclosed below results in a significant number of improvements in the tapper, partly by simplifying the overall mechanism. Costly downtime due to work clutches, damaged gears, worn belts or pulleys, worn leadscrews and leadscrew changeovers, ballscrew wear and replacement, and hydraulic seal leaks and spillage are eliminated. Tap changes in excess of 45 seconds, and other excessive changeover times due to many adjustments, are also eliminated.

Further improvements arise from the elimination of quality problems due to Jacobs tapper runout and mounting problems, double tapped or reamed holes, partially tapped and untapped holes caused by improper adjustments to limit switches which are manually adjusted, and out of specification threads from fluctuating air or hydraulic pressure or leadscrew or ballscrew error.

With the linear electric servo motor, and the encoder feedback, substantially all the tapping parameters can be pre-programmed and monitored through a motion controller with a built-in high speed processor through a touch screen interface. For example, in the preferred embodiment, all tapping parameters are programmed through the touch panel with very user-friendly screens, and a self-teach feature to establish depths has been added for first time set-up and job storage for up to 700 different job set-ups, each with up to 15 different parameters. As a result, with a touch screen panel, there are quick job changeovers, programmable depths, quick change taphead retract features and tap RPM in and RPM out (up to 7,500 rpm's) separately selectable for reduced cycle time all without manual adjustments. Moreover, tap pitches can be programmable slave driven from a master spindle (meaning if you increase the RPM in either direction, the feed rate automatically compensates to match tap pitch requiring no adjustments to maximize tool life and throughput). Also, this machine has a rapid advance feature to clear the tool for indexing of the parts when required.

Despite the simplification accomplished by using a linear electric servo motor, the new tapper is not limited as to vertical, horizontal or angular orientation or multiple spindle heads. With a reliable direct drive, very accurate rotational electric servo motors, and linear electric servo motors, increased tool life from exact feed rates and much faster cycle times than competitive machines are achieved.

### BRIEF DESCRIPTION OF THE DRAWINGS

FIG. 1 is a perspective view of the new tapper complete with an angular base;

FIG. 2 is an end view of the new tapper complete with an angular base;

FIG. 3 is a plan view of the new tapper complete with an angular base;

FIG. 4 is a perspective view of the complete tapper with exploded mounting plates or retrofit;

FIG. 5 is an exploded perspective view of the mechanical tapper;

FIG. 6 is a perspective view of the mechanical assembly;

FIG. 7 is an exploded perspective view of the mechanical assembly;

FIG. 8 is an exploded plan view of the mechanical assembly;

FIG. 9 is an exploded side view of the mechanical assembly;

FIG. 10 is a flow chart for the operator interface screen;

FIG. 11 is a picture of the main screen from FIG. 10;

FIG. 12 is a picture of the manual and jog screen from FIG. 10;

FIG. 13 is a picture of the set-up screen from FIG. 10;

FIG. 14 is a picture of the current monitor screen from FIG. 10;

FIG. 15 is a picture of the drill set-up screen from FIG. 10;

FIG. 16 is a perspective drawing of the tapper showing critical control panels; and

FIG. 17 is a schematic communications flow chart.

### DESCRIPTION OF THE PREFERRED EMBODIMENTS

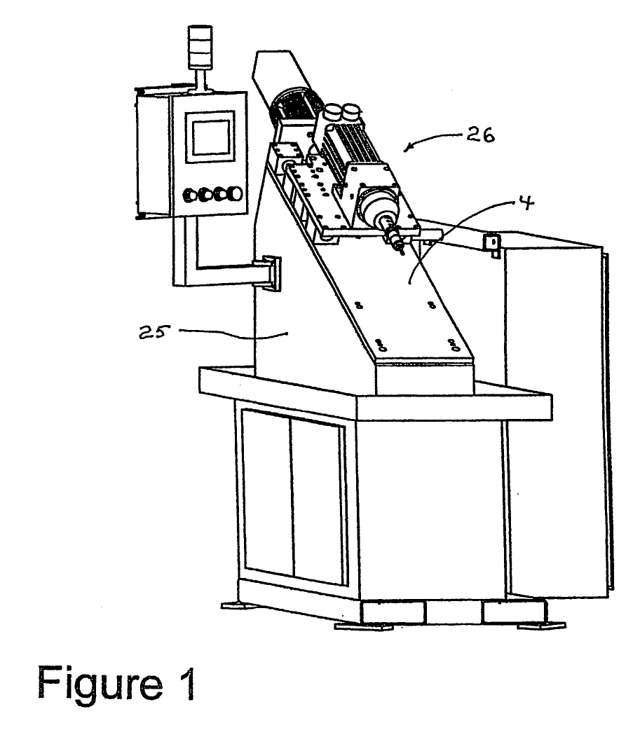

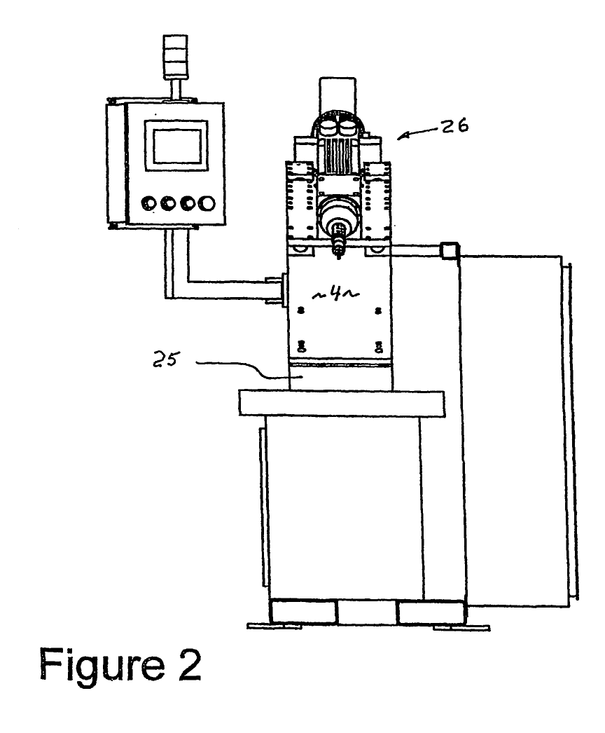

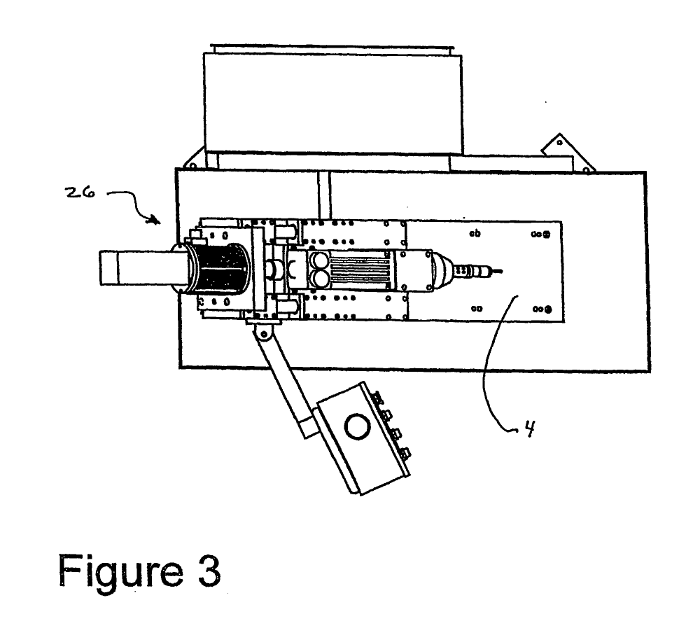

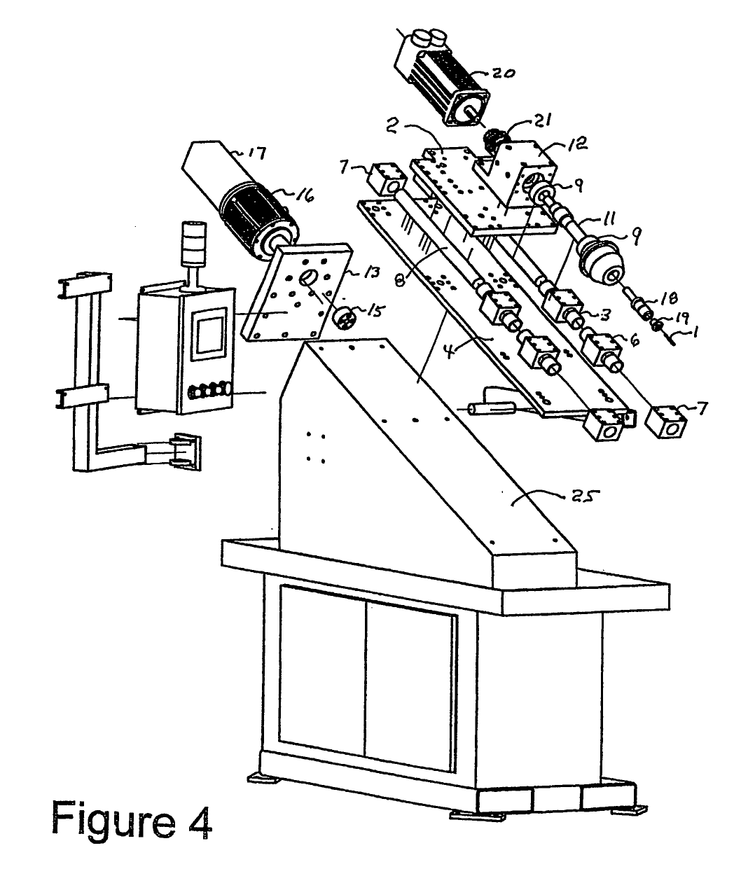

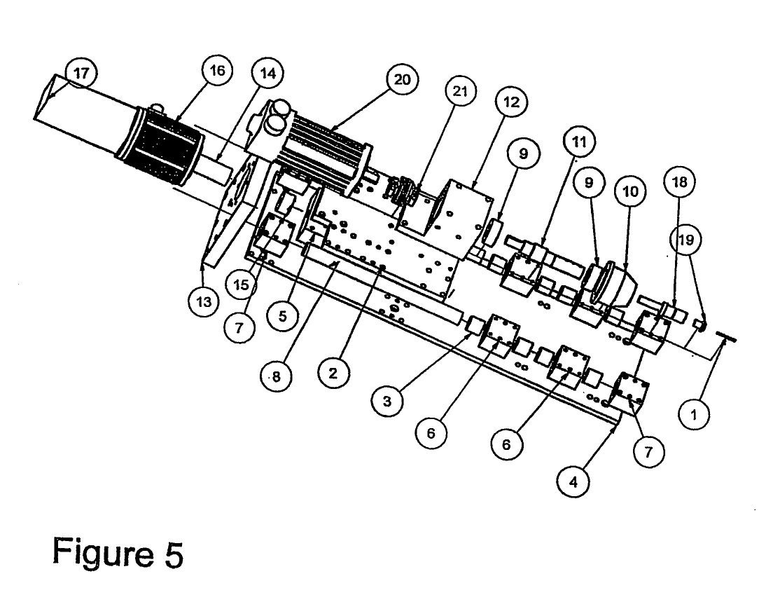

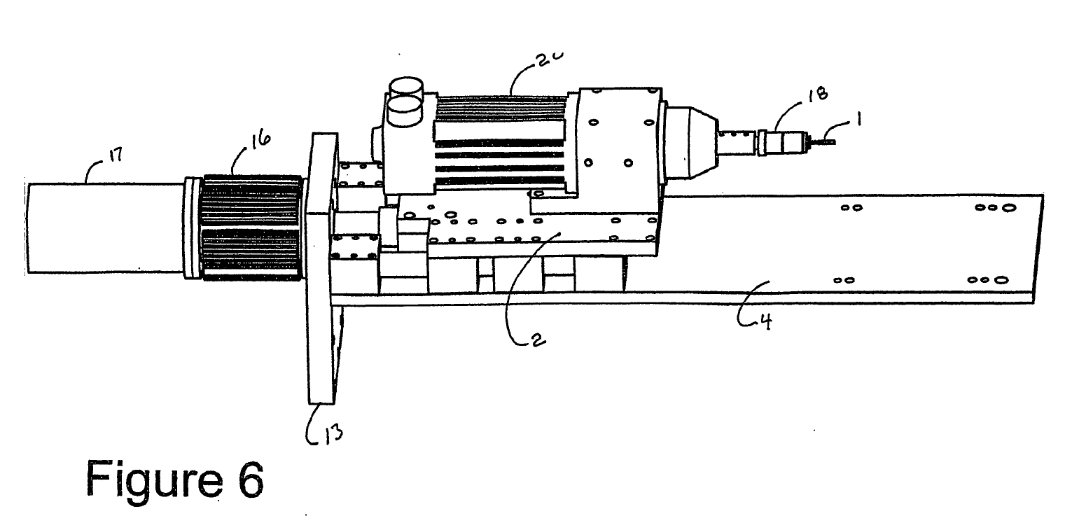

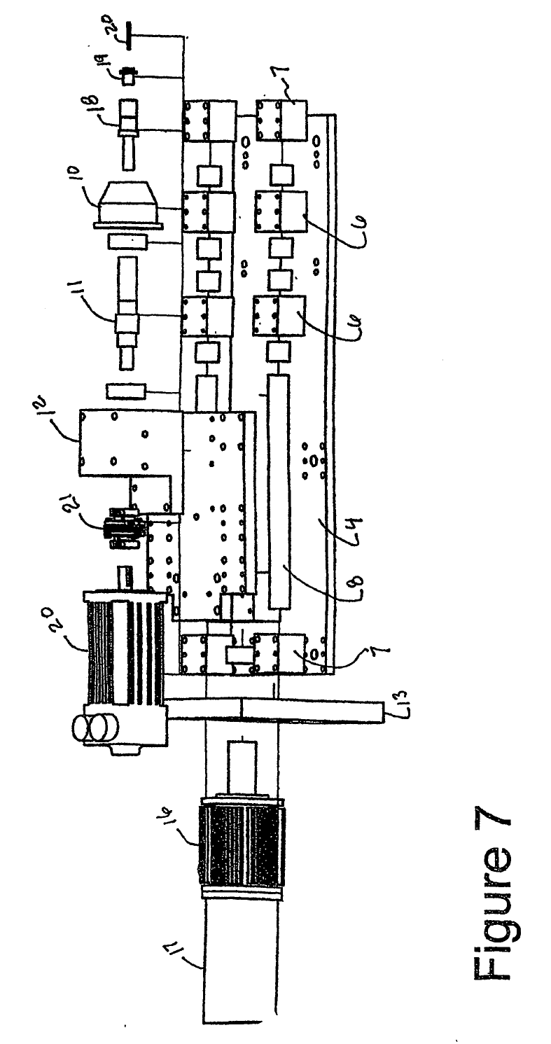

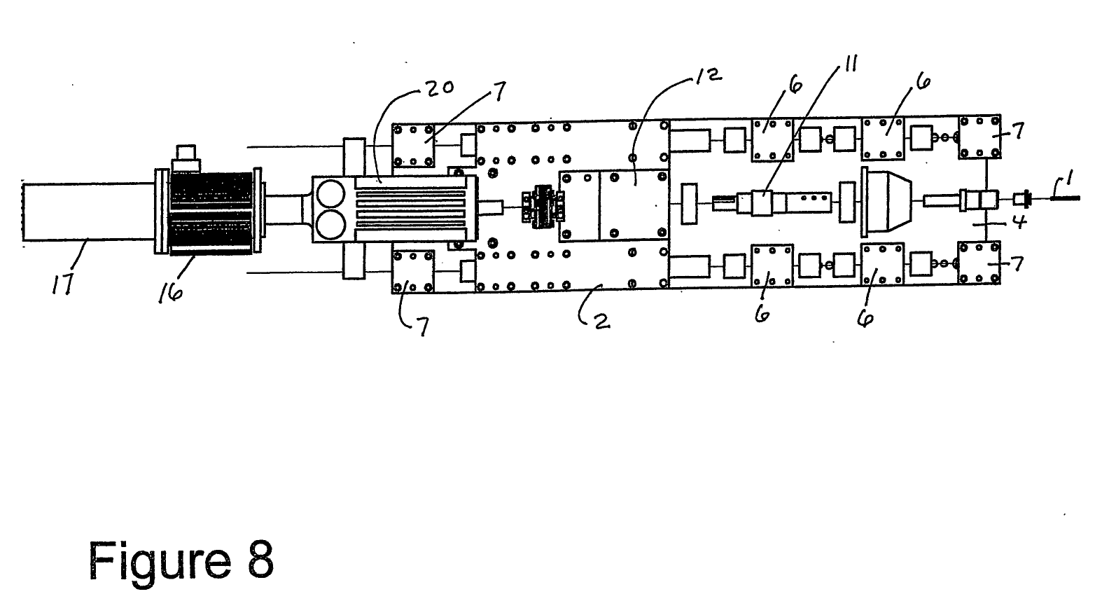

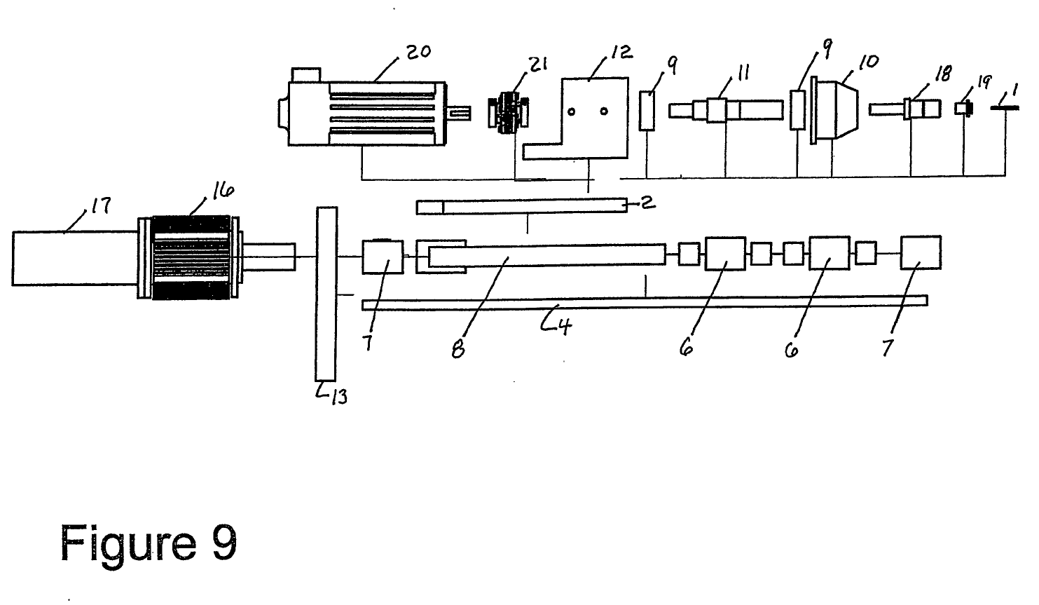

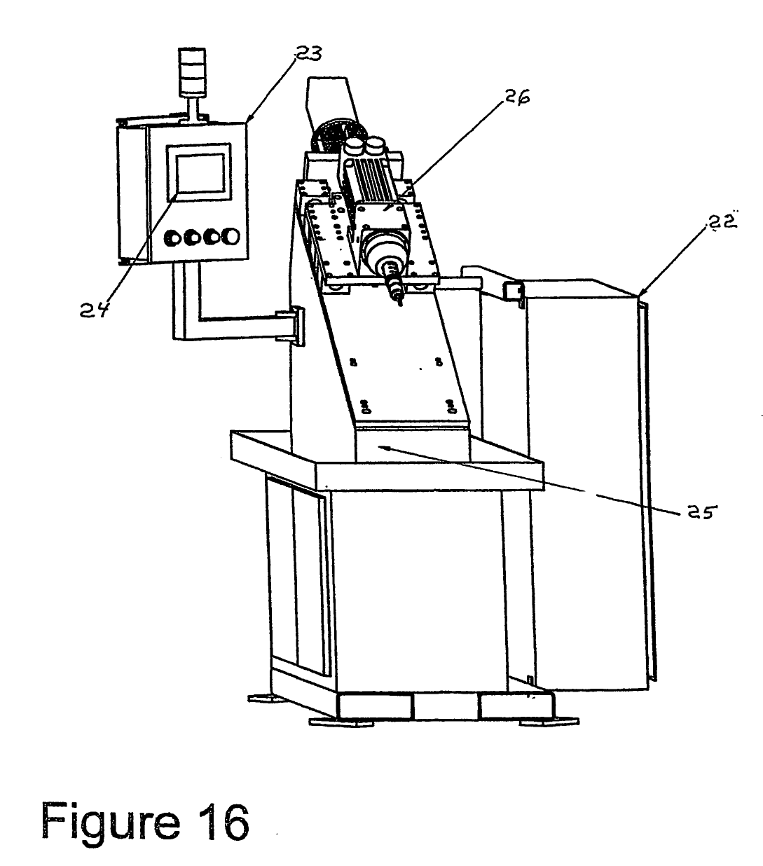

Illustrated in FIGS. 1 through 9 and 16 is the new tapper on angular mount base 25. The tapper is generally denoted by 26. A fixture (not shown) having sequential part feeding means would be mounted on the base 25 by means of the base sub plate 4. A fixture for retaining a part in proper position in relation to the axis of the tap 1, tool holder 18 and chuck 19 would also be mounted on the base sub plate 4.

Affixed to the upper surface of the base sub plate 4 are four guide rod mounts 7. A slide plate 2 is slideably attached by four guide rod slide mounts 6, all of which have two bushings 3 press fit for linear movement on guide rods 8. Affixed to upper side of slide plate 2 is the spindle motor mount 12 which retains one of two double angular contact bearings 9 for the spindle 11. The spindle motor mount also retains the misalignment coupling 21 inside, which couples the spindle servo output shaft to spindle 11. The rotational spindle servo 20 is affixed to the back side of motor mount 12, and the nose piece 10, which retains the second double angular contact bearing, is affixed to the front side. When activated, spindle servo 20 rotates, moving clockwise to tap or drill into a work piece and counter clockwise (except in drill mode) to retract out of work piece. Linear slide plate 2 on the under side has affixed to it the linear slide mount 5, which is affixed to the armature transition mount 15. Armature transition mount 15 is affixed to the armature 14 of linear electric servo motor 16 which, when activated, drives the slide plate 2 linearly on the guide rods 8 while providing accurate feed rate synchronized to the spindle servo 20 by programmed pitch coordinated with programmed rpm.

A linear motor mount 13 and encoder 17 is attached to the back of the machine base 25, unless provided as a weldment or retrofit to support the linear electric servo motor 16. The armature 14 passes through a hole in the linear mount 13 and attaches to the armature transition mount 15.

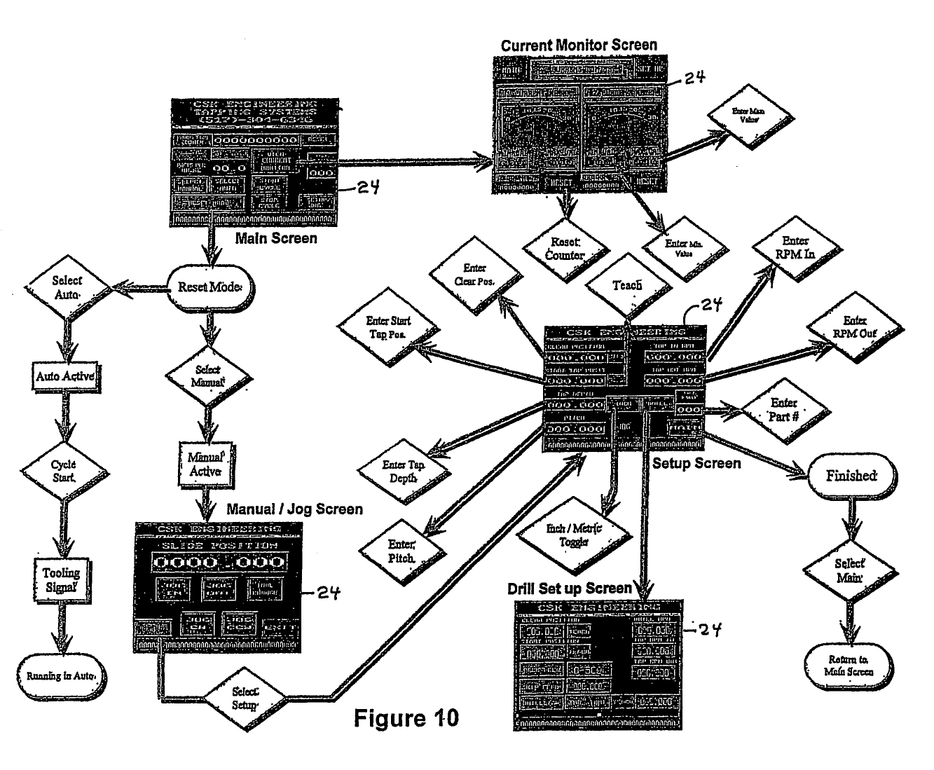

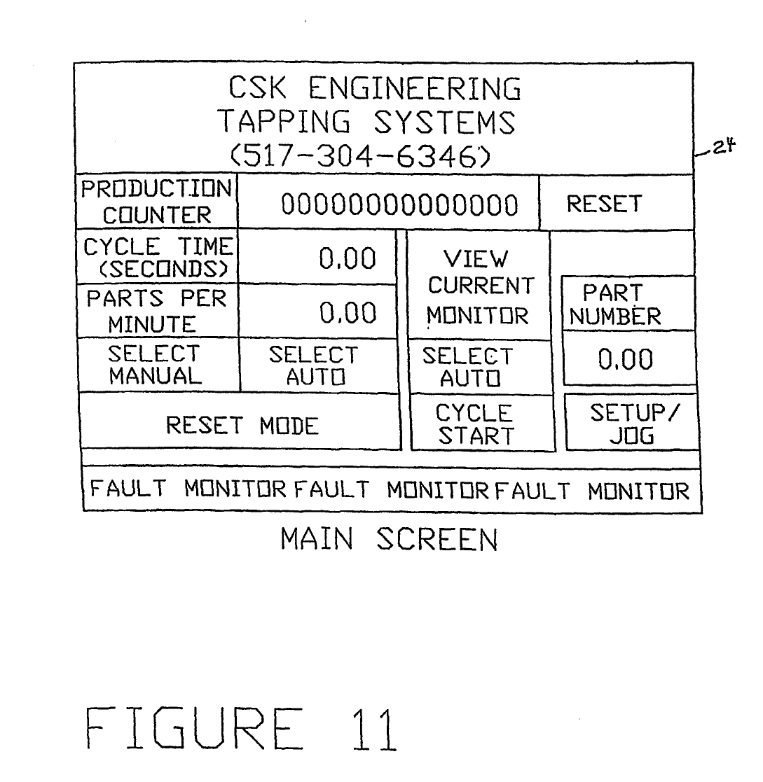

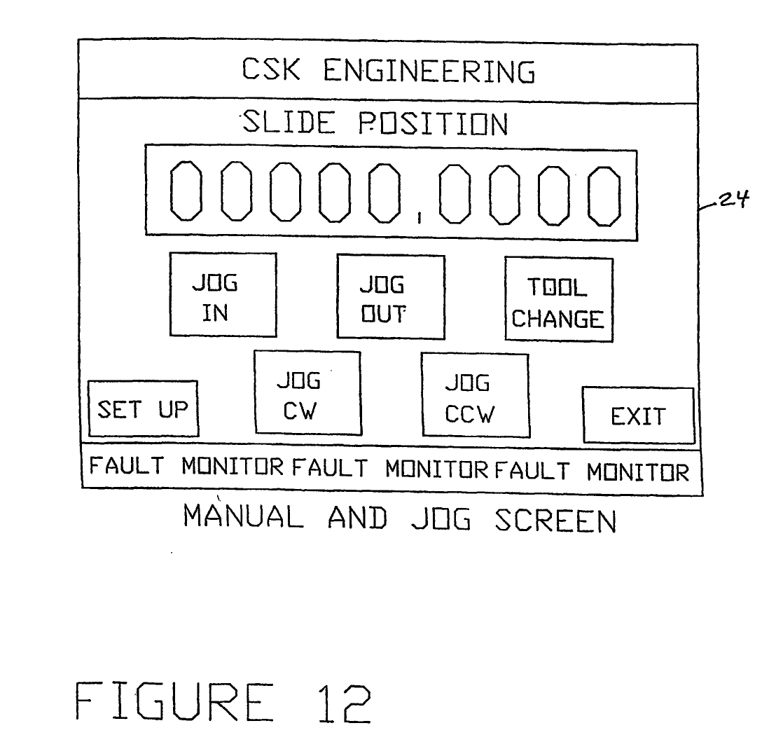

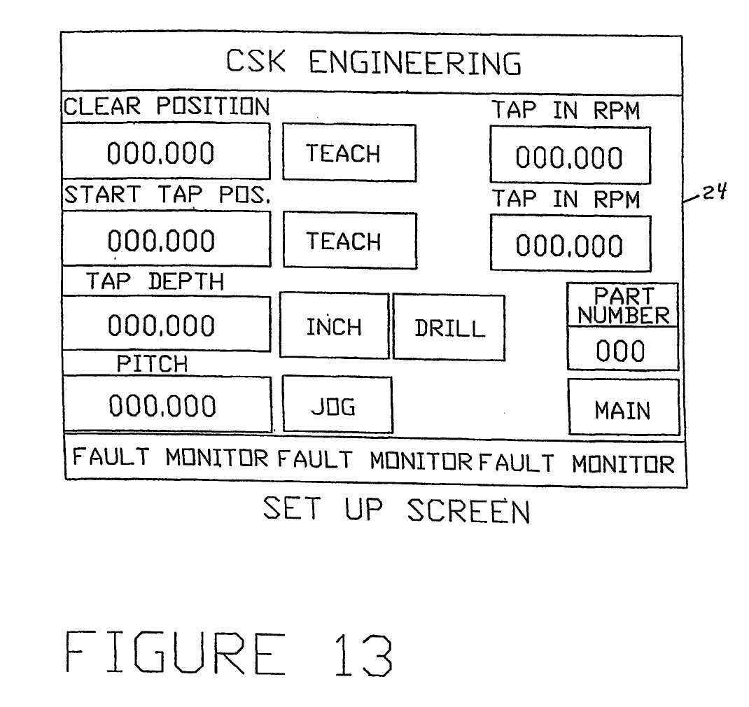

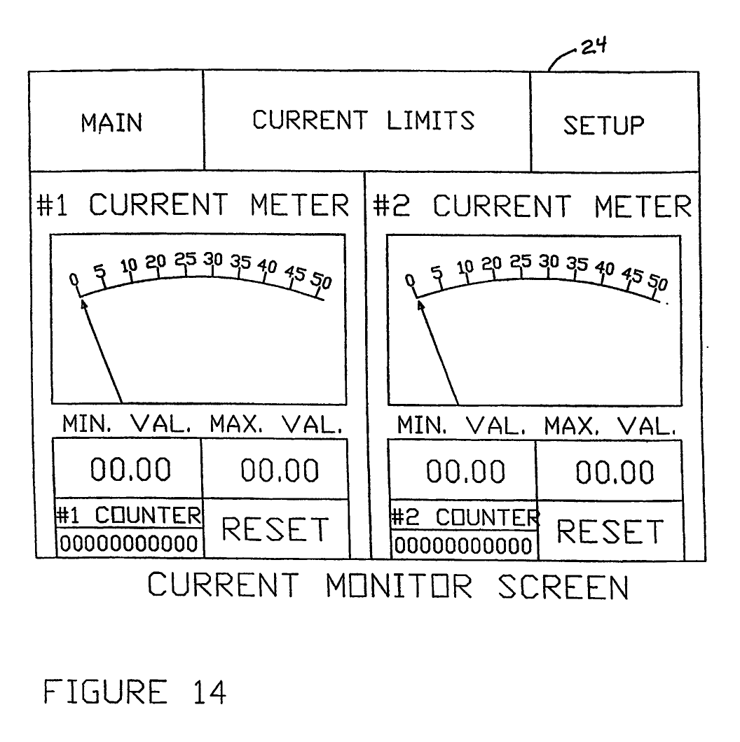

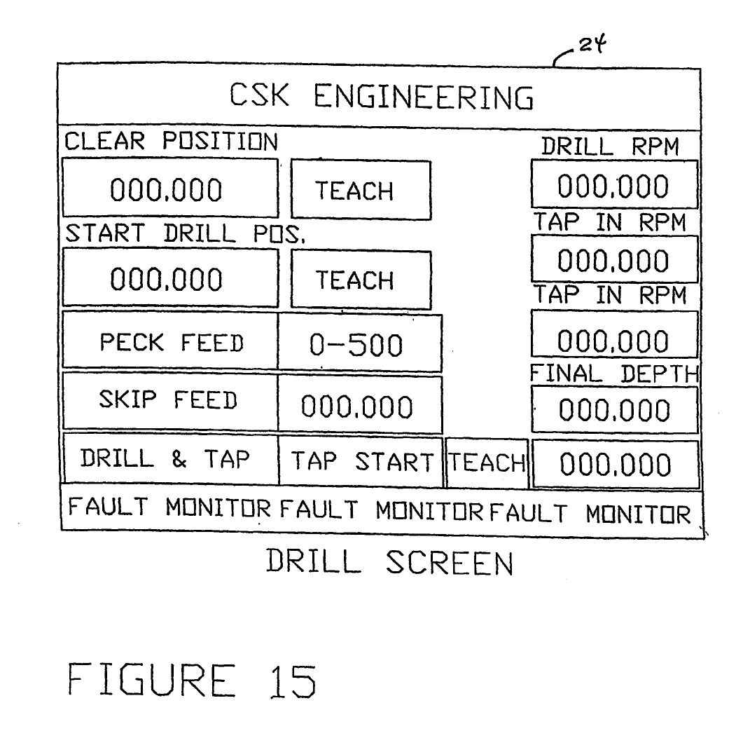

The basic control functions are illustrated in FIGS. 10 through 16 wherein a touch screen 24 in the operator control panel 23 permits an operator to both set up the parameters for a new part to be tapped or monitor tapping performance in real time for current production. FIG. 10 illustrates the touch screen 24 display for a typical set-up of a new part, as well as auto and manual modes. The motion controller in the master control panel 22 comprises principally a micro computer with memory sufficient for all parameters for all expected jobs or parts. The motion controller in turn directly controls the drives to send a specified current to the spindle servo 20 and the linear motor 16 to reach programmed speeds and feeds. The linear electric servo motor 16 is equipped with an encoder 17 to feed back armature 14 linear position, velocity and acceleration to the motion controller. Similarly, the spindle motor 20.is equipped with a resolver to feed back output shaft and spindle 11 rotational position, velocity and acceleration. In production, each part can be tapped in some one-half of a second. The cycle time can be significantly reduced by optimizing various steps as the job is set up. For example, the rotational speed of the tap is limited by strength of the tap and heat buildup during thread cutting. During retraction of the tap, the rotational and linear speed of the tap can be greatly increased to reduce cycle time. As shown in FIG. 10, the “RPM in” is programmed separate from that of the RPM out and can be set at speeds of up to 7,500 RPM's, thereby reducing the time to retract the tap in some cases to less than one-tenth of the tap cutting time. FIG. 10 illustrates the logical sequence for an operator to program in a new part by part number.

The operator enters on the touch screen the parameters and other information in sequence, as shown in the flow chart. In FIG. 10, no mechanical adjustments are required, unless the new part requires a change in the tooling fixture or a change in the tap. In the new part set-up, the computer program computes internal parameters, such as number of tap rotations and linear travel per rotation, from the parameters entered by the operator on the touch screen 24.

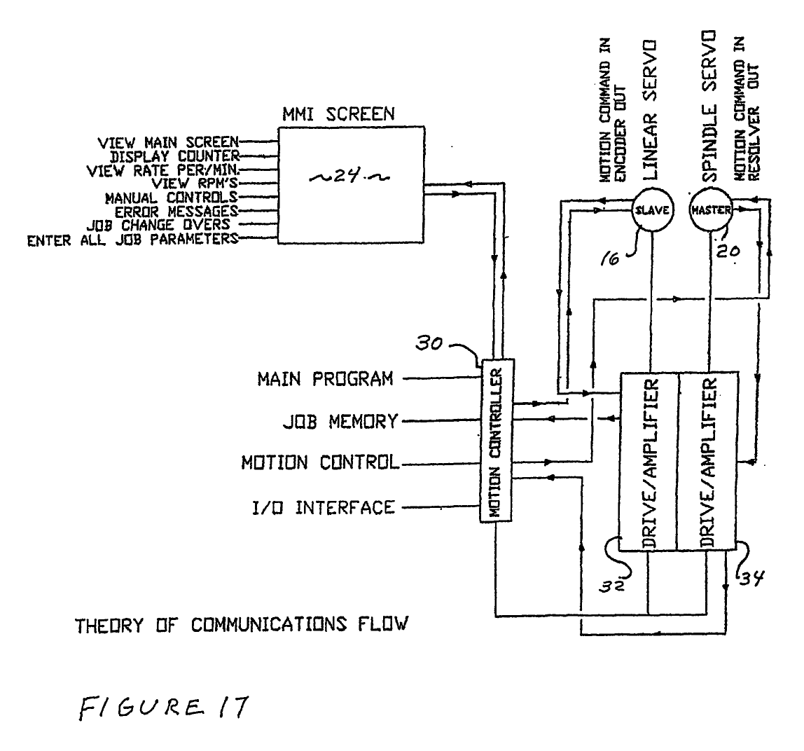

The basic control functions are illustrated in FIG. 17 wherein the touch screen 24 permits an operator to both set up the parameters for a new part to be tapped or monitor tapping performance in real time for current production. As noted above, the motion controller 30 comprises principally a micro computer with memory sufficient for all parameters for all expected jobs or parts. The motion controller 30 in turn directly controls through drive amplifiers 32 and 34 the linear electric servo motor 16 and the spindle electric servo motor 20.

1. A thread tapper and drill machine comprising a servo spindle motor and spindle, at least one mount supporting the spindle motor and spindle, said mount supported on means on abase to provide for linearly guided movement of the spindle motor and spindle relative to the base, and
means on the spindle for axially attaching a tap thereto,
the improvement comprising an electric linear servo motor mounted on said base, said electric linear servo motor having an armature, the armature having at least one end, the end attached to the at least one mount of the servo spindle motor and spindle,
whereby the spindle motor can impart controlled rotational movement to the spindle and the linear electric motor can impart controlled axial movement to the spindle.

2. A thread tapper comprising a spindle, an electric rotational servo motor to impart rotational movement to the spindle, an electric linear servo motor to impart linear movement to the spindle and means on the spindle to attach a tap thereto,
a motion control computer in electrical communication with the rotational servo motor and linear servo motor, a touch screen and a memory in electrical communication with the computer, and
software installed in the computer to respond to set-up parameters from the touch screen, including linear extension and retraction limits, number of rotations, linear speed and rotational speed.

3. The thread tapper of claim 2 wherein the software includes a production mode for cyclic operation of the tapper and real time monitoring on the touch screen of the production mode.
